(19) United States
(12) Patent Application Publication
(10) Pub. No.: US 2026/0184971 A1
(43) Pub. Date: Jul. 2, 2026

(54) AMORPHOUS EVA-POLYMERS AND THEIR USE

(71) Applicant: ARLANXEO DEUTSCHLAND GMBH, Dormagen (DE)

(72) Inventors: Tanja PAUL, Dormagen (DE); Wenyu ZHANG, Shanghai, Shanghai (CN); Jing Zhe JIANG, Jiangsu (CN); Martin HOCH, Shanghai, Shanghai (CN)

(73) Assignee: ARLANXEO DEUTSCHLAND GMBH, Dormagen (DE)

(21) Appl. No.: 18/863,872

(22) PCT Filed: May 9, 2023
(86) PCT No.: PCT/EP2023/062184

§ 371 Date: Nov. 7, 2024

(30) Foreign Application Priority Data
May 9, 2022 (WO) PCT/CN2022/091717

(51) Int. Cl. C09J 11/08; C08F 218/08; C09J 5/06; C09J 175/08

(52) U.S. Cl. CPC C09J 11/08; C08F 218/08; C09J 5/06; C09J 175/08; C08F 2800/20

(57) ABSTRACT

An adhesive composition comprising a moisture-curable polyurethan-based adhesive and a polymer comprising units derived from ethylene and vinyl acetate and having a melt-flow index at 196° C. and a load of 2.16 kg of 10 to 250 g/10 min, preferably between 30 and 100 g/10 min, wherein the polymer comprises at least 8% by weight of units derived from ethylene and from 62 to 92% by weight of units derived from vinyl acetate, wherein the % by weight is based on the total weight of the polymer which is 100%. Also provided are polymers comprising units derived from ethylene and vinylacetate and having a melt-flow index at 196° C. and a load of 2.16 kg of 10 to 250 g/10 min, preferably 30 to 100 g/10 min, wherein the polymer comprises at least 8% by weight of units derived from ethylene and from 69 to 92% by weight of units derived from vinyl acetate, wherein the % by weight is based on the total weight of the polymer which is 100%. Further are provided process for making adhesive compositions, for making bonds and bonded articles.

### BACKGROUND

Copolymers comprising ethylene and vinyl acetate with a vinyl acetate content of less than 40% by weight generally are crystalline thermoplastics. Copolymers comprising ethylene and vinyl acetate, and optional other comonomers with a vinyl acetate content between 40 and 90% wt. are elastomers will be referred herein as EVA-copolymers.

The major or even exclusive components of the EVA-copolymers, i.e., the ethylene and vinyl acetate monomers, typically are obtained from fossil resources, for example by distillation from fossil raw materials in so-called naphtha-crackers. However, as described, for example, in international patent application WO2019/202405 A1, both monomers can also be obtained from sustainable resources, for example from renewable sources such as plants including sugar canes. To obtain ethylene from a renewable source (also referred to as “bio-based ethylene”), the renewable source is first fermented to produce ethanol. The ethanol is then subjected to a dehydration reaction to form ethylene. For making bio-based vinyl acetate the renewable source is fermented to produce ethanol, which is then oxidized to form acetic acid. The acetic acid is then reacted with ethylene (which may also be a bio-based ethylene) to produce vinyl acetate.

Both monomers may also be obtained from recycled materials, for example recycled plant-based materials or recycled plastic or rubber, for example obtained by pyrolysis. Both, the use of monomers obtained from recycled materials or from renewable sources will reduce the carbon dioxide footprint of the polymer production (see, for example WO2019/202405 A1 or Pete Spanos et al, Sustainable Keltan EPDM in rubberworld.com, pages 46-52, April 2023, where the principle has been demonstrated for the generation and use of ISCC+-certified ethylene in EPDM polymers. The principles shown there for ethylene-propylene-diene polymers (EPDM) can be applied also to the use of ethylene and vinylacetate for making EVA-copolymers).

EVA-copolymers are used in many rubber applications. Specific examples include the use of EVA-copolymers as
(i) a tie layer or a component of a tie layer in multi-layer articles including multi-layer-films,
(ii) a binder or component of a binder, including binder for master-batching of reactive chemicals or binder in battery applications, for example as binder of an anode or a cathode material,
(iii) a polymeric plasticizer or component thereof, including plasticizer for thermoplastic resins including, for example, polyvinyl chlorides,
(iv) as impact modifier preferably of thermoplastic resins or
(v) as ingredient of foams.

Examples for using EVA-copolymers as additives for rubbers and thermoplastic materials are described, for example, in GB1389342 and EP4071213A1

If used in layered articles, the EVA-copolymer may be present in an interior, an exterior or an intermediate layer.

EVA copolymers can also be used as cable sheaths or tubing or as a component thereof. Cables include but are not limited to coaxial cables, twisted pair cables, power cables including high voltage and low voltage cables, optical fiber cables, data cables, continuous-flex cables.

EVA copolymers may also be used as component for making blends with other rubbers or with one or more thermoplastic polymers, including, for example, blends with polyamides, for example to produce thermoplastic vulcanizate (TPV's) as disclosed for example in EP2098566B1 or thermosets as disclosed for example in EP2895552B1.

EVA-copolymers are frequently used as a component of adhesive compositions. Adhesives include, for example, pressure-sensitive adhesives (PSA's), solvent-based adhesives, moisture-curing adhesives, hot-melt adhesives. EVA-copolymers may also be components of the adhesive of adhesives tapes, including double-sided tapes and masking tapes.

EVA-copolymers can also be used to impart flame retardancy or improve damping behavior.

EVA-copolymers with vinyl acetate contents between 40 and 90% by weight are commercially available from ARLANXEO Deutschland GmbH under the tradenames LEVAPREN and LEVAMELT. However, EVA-copolymers with a high content of vinyl acetate are only available as grades having a high melt flow index of 6 or less g/10 min. The properties of commercial LEVAPREN and LEVAMELT grades are shown in tables 1 and 2.

TABLE 1
LEVAPREN

| EVA-copolymer | VA-content | Mooney viscosity |
|---|---|---|
| grade | (% wt) | ML1 + 4,100° C. |
| LEVAPREN 400 | 40 +/− 1.5 | 20 +/− 4 |
| LEVAPREN 450 | 45 +/− 1.5 | 20 +/− 4 |
| LEVAPREN 500 | 50 +/− 1.5 | 27 +/− 4 |
| LEVAPREN 600 | 60 +/− 1.5 | 27 +/− 4 |
| LEVAPREN 650 | 65 +/− 2.0 | 27 +/− 4 |
| LEVAPREN 700 | 70 +/− 1.5 | 27 +/− 4 |
| LEVAPREN 800 | 80 +/− 2.0 | 28 +/− 6 |
| LEVAPREN 900 | 90 +/− 2.0 | 38 +/− 6 |

TABLE 2
LEVAMELT

| | | Melt flow index |
|---|---|---|
| EVA-copolymer | VA-content | (190° C., 2.16 kg) |
| grade | (% wt) | g/10 min |
| LEVAMELT 400 | 40 +/− 1.5 | 3 +/− 2 |
| LEVAMELT 450 | 45 +/− 1.5 | 3 +/− 2 |
| LEVAMELT 452 | 45 +/− 1.5 | 10 +/− 5 |
| LEVAMELT 456 | 45 +/− 1.5 | 25 +/− 10 |
| LEVAMELT 500 | 50 +/− 1.5 | 2.75 +/− 1.25 |
| LEVAMELT 600 | 60 +/− 1.5 | 2.75 +/− 1.25 |
| LEVAMELT 650 | 65 +/− 2.0 | 4 +/− 2 |
| LEVAMELT 686 | 68 +/− 2.0 | 25 +/− 10 |
| LEVAMELT 700 | 70 +/− 1.5 | 4 +/− 2 |
| LEVAMELT 800 | 80 +/− 2.0 | 4 +/− 2 |
| LEVAMELT 900 | 90 +/− 2.0 | 4 +/− 3 |

There is a need to provide further EVA-copolymers. There is also a need to provide EVA copolymers for improving adhesive compositions, in particular hot melt adhesives.

Reactive hot melt polyurethane adhesives are widely used as adhesives in packaging, textiles, furniture, automotive industry, and many others because they provide a high bond strength, good weather resistance and do not require solvents. Polyurethane (PUR) adhesives can be synthesized by reacting a stoichiometric excess of diisocyanate with one or more polyols to create so-called “prepolymers” with terminal isocyanate groups. When the prepolymer composition is applied to a substrate the isocyanate groups interact with moisture from the atmosphere or the substrate and forms a network structure creating an adhesive bond when applied between substrates. These reactions are known as moisture curing. The PUR hot melt adhesives are generally solid at room temperature and stored under moisture-free conditions. They are heated prior to their application and are applied to the substrate in a fluid state where they cure and solidify by forming an adhesive bond, a film, or a coating. Hot melt PUR adhesives are described, for example, in United States patent application No. US 2021/0062055A1.

For practical use of PUR hot melt adhesives their open time is important, which is the time after the adhesive has been applied to a substrate and until a serviceable bond is made. During the open time the substrates can still be moved and adjusted. It is known to add non-reactive polymers or other additives to PUR hot melt adhesives for increasing the open time.

There is a continuous need for providing alternative PUR adhesive compositions with good opening times and that preferably can be prepared easily, for example at comparatively low temperatures.

### SUMMARY

Therefore, in one aspect there is provided an adhesive composition comprising a moisture-curable polyurethan-based adhesive and a polymer comprising units derived from ethylene and vinyl acetate and having a melt-flow index at 196° C. and a load of 2.16 kg of 10 to 250 g/10 min, preferably between 30 and 100 g/10 min, wherein the polymer comprises at least 8% by weight of units derived from ethylene and from 62 to 92% by weight of units derived from vinyl acetate, wherein the % by weight is based on the total weight of the polymer which is 100%.

In another aspect there is provided a vinyl-derived polymer comprising units derived from ethylene and vinylacetate and having a melt-flow index at 196° C. and a load of 2.16 kg of 10 to 250 g/10 min, preferably 30 to 100 g/10 min, wherein the polymer comprises at least 8% by weight of units derived from ethylene and from 69 to 92% by weight of units derived from vinyl acetate, wherein the % by weight is based on the total weight of the polymer which is 100%. In a further aspect there is provided a process of making the adhesive composition comprising
a) dissolving the vinyl-derived polymer according into at least one polyol,
b) reacting the mixture obtained in a) with at least one polyisocyanate, and, optionally,
c) adding at least one additive.

In yet another aspect there is provided a bonded substrate comprising a bond obtained with the adhesive composition.

In a further aspect there is provided a method of bonding a substrate comprising applying the adhesive composition between a first substrate and a second substrate such that the first and second substrate are at least partially connected to each other by the adhesive composition and subject the adhesive composition to curing to bond the first to the second substrate.

In yet a further aspect there is provided a method of preparing a coating comprising applying the adhesive composition onto a substrate and subjecting the composition to curing. In another aspect there provided a coating obtainable by the process.

### DETAILED DESCRIPTION

In the following description norms may be used. If not indicated otherwise, the norms are used in the version that was in force on Mar. 1, 2020. If no version was in force at that date because, for example, the norm has expired, the version is referred to that was in force at a date that is closest to Mar. 1, 2020.

In the following description the amounts of ingredients of a composition or polymer may be indicated interchangeably by “weight percent”, “wt. %” or “% by weight”. The terms “weight percent”, “wt. %” or “% by weight” are based on the total weight of the composition or polymer, respectively, which is 100% unless indicated otherwise.

The term “phr” means parts per hundred parts of rubber, i.e., the weight percentage based on the total amount of rubber which is set to 100%.

Ranges identified in this disclosure include and disclose all values between the endpoints of the range including the end points unless stated otherwise.

The term “substituted” is used to describe hydrocarbon-containing organic compounds where at least one hydrogen atom has been replaced by a chemical entity other than a hydrogen.

That chemical entity is referred to herein interchangeably as “substituent”, “residue” or “radical”. For example, the term “a methyl group substituted by fluorine” refers to a fluorinated methyl group and includes the groups —CF₃, —CHF₂ and —CH₂F. The term “unsubstituted” is meant to describe a hydrocarbon-containing organic compound of which none of its hydrogen atoms have been replaced. For example, the term “unsubstituted methyl residue” refers to a methyl, i.e. —CH₃.

The terms “comprising”, “containing” and “having” are used in an open, non-limiting meaning. For example, the phrase “a composition comprising ingredients A and B” is meant to include ingredients A and B but other ingredients may or may not be present. Contrary to the use of “comprising”, “containing” or “having” the word “consisting of” is used in a narrow, limiting meaning. The phrase “a composition consisting of ingredients A and B” is meant to describe a composition with ingredients A and B and no other ingredients.

### Adhesive Compositions

The adhesive compositions according to the present disclosure are moisture-curable polyurethane-based adhesives and comprise an isocyanate-terminated prepolymer and as additive one or more amorphous ethylene-vinyl acetate polymers. The prepolymer includes the reaction product of an excess of at least one polyisocyanate with at least one polyol. Useful isocyanate-terminated polyurethane prepolymers include, e.g., the reaction product of a crystalline polyester polyol, polyether polyol, diisocyanate, and optionally other polyols, the reaction product of crystalline polyester polyol, diisocyanate, and optionally other polyols, the reaction product of polyether polyol, diisocyanate, and optionally other polyols, the reaction product of a crystalline polyester polyol, an amorphous polyester polyol, diisocyanate, and optionally other polyols, preferably selected from at least one polyether polyol, and any combination thereof. The stoichiometric ratio of isocyanate groups (NCO) to the sum of the hydroxyl groups (OH) present on the polyol(s) used to form the isocyanate terminated polyurethane prepolymer preferably is no greater than 3.5:1, from 3:1 to 2.5:1, from 2.3:1 to 2.1:1. The prepolymers can be prepared as is known in the art.

Ethylene-vinylacetate polymers may be used that are produced using bio-based monomers or monomers from recycled bio-based or non-biobased materials. Therefore, adhesive compositions may be prepared that have a reduced CO₂-footprint. In one embodiment the adhesive composition has a content of bio-based carbon of at least 1%, at least 5%, at least 10% or at least 25% as determined according to ASTM D6866-18, method B.

### Polyester Polyols

The polyester polyols from which the polyurethane prepolymer is derived have at least two hydroxyl groups. The polyester polyols preferably have a number average molecular weight (Mn) of at least 1000 g/mol, for example from 2000 g/mol to 4000 g/mol. Suitable polyester polyols include the reaction product of at least one diol (e.g., an aliphatic diol having a carbon chain of at least 2 carbon atoms, a cycloaliphatic diol, and combinations thereof), and at least one diacid (e.g., an aliphatic diacid, an aromatic diacid, and combinations thereof, having at least 10 carbon atoms, at least 12 carbon atoms, at least 14 carbon atoms, from 10 carbon atoms to 20 carbon atoms, from 12 carbon atoms to 20 carbon atoms, or even from 12 to 16 carbon atoms). One example of a useful aliphatic diol is ethylene glycol. Examples of suitable diacids include 1,12-dodecanedioic acid, 1,14-tetradecanedioic acid, sebacic acid, and combinations thereof. Specific examples of useful crystalline polyester polyols include ethylene glycol/tetradecane-dioic acid, ethylene glycol/dodecanedioic acid, and mixtures thereof. Useful crystalline and amorphous polyester polyols are commercially available under a variety of trade designations, including, e.g., the DYNACOLL series of trade designations from Evonik Industries AG. Useful crystalline polyester polyols have a melting point of at least 35° C., preferably at least 65° C. (determined by differential scanning calorimetry, DSC) and/or a melt endotherm above 50 J/g. Amorphous polyester have a DSC Tg (glass transition temperature) below 40° C. and/or a melt endotherm below 20 J/g. The crystalline polyester chains provide high modulus and strong bond-lines due to their ability to harden when cooling down. The degree of crystallization and the speed of crystallization can be adjusted by varying the type of polyester polyol.

Amorphous polyesters keep their softness when cooling down but do not provide sufficient bond strength when used alone. Therefore, it is typical that PUR formulators use blends of amorphous and crystalline polyesters to balance the need for a high enough bond strength after cooling and still long enough open time and peel tack in the initial stage of the bonding process.

Preferably, the polyester polyols are in liquid state below a temperature of 150° C. or below 130° C., preferably, they are liquid at a temperature about 120° C. Preferably, the polyester polyols have a molecular weight between 2 and 10 kg/mol.

### Polyether Polyols

The polyether polyol from which the polyurethane prepolymer is derived have at least two hydroxyl groups. Useful polyether polyols include linear and branched polyether homopolymers and copolymers and the polyether polyol copolymers can have a variety of configurations including, e.g., random and block configurations. The polyether polyol may be derived from cyclic oxide monomers (e.g., ethylene oxide, propylene oxide, 1,2-butylene oxide, 1,4-butylene oxide, and tetrahydrofuran), and optionally a polyfunctional initiator having at least two active hydrogens including, e.g., polyhydric alcohols (e.g., ethylene glycol, propylene glycol, diethylene glycol, cyclohexane dimethanol, glycerol, trimethylol-propane, pentaerythritol and bisphenol A), ethylenediamine, propylene diamine, triethanolamine, 1,2-propanedithiol, and combinations thereof. Suitable alkylene oxide capped polyether polyols include the reaction product of an adduct of a first component (e.g., ethylene glycol, propylene glycol, diethylene glycol, dipropylene glycol, triethylene glycol 2-ethylhexanediol-1,3-glycerin, 1,2,6-hexane triol, trimethylol propane, trimethylol ethane, tris(hydroxyphenyl) propane, and combinations thereof), and a second component (e.g., ethylene oxide, propylene oxide, butylene oxide, and combinations thereof). Particularly useful polyether polyols include polyethylene glycol, polypropylene glycol, the reaction product of propylene oxide or butylene oxide capped or copolymerized with ethylene oxide (e.g., ethylene oxide capped propylene glycol), polytetramethylene ether glycol, and combinations thereof. Suitable commercially available polyether polyols are available under a variety of trade designations including, e.g., under the trade designation TERATHANE including TERATHANE 2000 polytetramethylene ether glycol and TERATHANE 1000 polyether glycol, under the trade designation VORANOL VORANOL 220-056 polyether polyol and VORANOL 2000 L polypropylene glycol, under the trade designation DESMOPHEN, ARCOL and ACCLAIM including DESMOPHEN 2061 13D polypropylene ether polyol, DESMOPHEN 2060 BD polypropylene polyether polyol, ARCOL PPG-2000 polypropylene glycol ARCOL PPG-1000 polypropylene glycol, and ACCLAIM Polyol 703 polypropylene glycol, and PolyG polypropylene glycols and POLY-G 55-56 ethylene-oxide capped polyethylene glycol. Preferably, the polyether polyols are in liquid state below a temperature of 150° C. or below 130° C., preferably, they are liquid at a temperature about 120° C.

### Diisocyanate

The diisocyanate from which the polyurethane prepolymer is derived can be any suitable diisocyanate including, e.g., aromatic diisocyanates, aliphatic diisocyanates, clycloaliphatic diisocyanates, and combinations thereof. Useful aromatic diisocyanates include, e.g., diphenyl methylene diisocyanate (MDI), (e.g., diphenylmethane-2,4′-diisocyanate (i.e., 2,4′-MDI), diphenylmethane-2,2′-diisocyanate (i.e., 2,2′-MDI), diphenylmethane-4,4′-diisocyanate (i.e., 4,4′-MDI), and combinations thereof), tetramethylxylene diisocyanate, naphthalene diisocyanate (e.g., naphthalene-1,5-diisocyanate, naphthalene-1,4-diisocyanate, and combinations thereof), toluene diisocyanate (TDI) (e.g., 2,4-TDI, 2,6-TDI, and combinations thereof), and combinations thereof. Useful cycloaliphatic diisocyanates include, e.g., 1-isocyanatomethyl-3-isocyanato-1,5,5-trimethyl-cyclohexane (i.e., isophorone diisocyanate (i.e., IPDI), 1-methyl-2,4-diisocyanato-cyclohexane, 1,4-diisocyanato-2,2,6-trimethylcyclohexane (i.e., TMCDI), hydrogenation products of the aforementioned aromatic diisocyanates (e.g., hydrogenated 2,4′-MDI, hydrogenated 2,2′-MDI, hydrogenated 4,4′-MIDI and combinations thereof), and combinations thereof. Useful aliphatic diisocyanates include, e.g., hexamethylene diisocyanate (e.g., 1,6-diisocyanato-2,2,4-trimethylhexane, 1,6-diisocyanato-2,4,4-trimethylhexane diisocyanate, and combinations thereof), lysine diisocyanate, dodecane diisocyanate, dimer diisocyanate, and combinations thereof.

The isocyanate-terminated prepolymer optionally is stripped of residual monomeric diisocyanate such that the amount of monomeric diisocyanate is less than 0.5% by weight, less than 0.25% by weight, or even less than 0.1% by weight diisocyanate monomer.

Useful diisocyanate monomers are commercially available under a variety of trade designations including, e.g., the DESMODUR and MODUR including, e.g., DESMODUR 440; MODUR M 4,4′-MDI, LUPRANATE M 4,4′-MDI and RUBINATE 44.

### Vinyl-Derived Polymers

The adhesive compositions according to the present disclosure comprise at least one vinyl-derived polymer as an additive. The addition of the vinyl-derived polymer to the adhesive composition preferably increases the open time of the adhesive. Suitable vinyl-derived polymers include polymers that comprise at least 8% by weight of units derived from ethylene and from 62% to 92% by weight of units derived from vinyl acetate and therefore, the vinyl-derived polymers are referred to herein also as “ethylene-vinylacetate copolymers”. Preferably the vinyl-derived polymer comprises from 69% to 85% by weight, more preferably from 70% to 85% by weight of units derived from vinyl acetate, based on the total weight of the polymer which is 100%. Ethylene vinyl acetate copolymers with a low vinyl acetate content are crystalline. For example, the melting temperature of such polymer can be as high as 100° C. for a vinyl content of 5% and decreases to values around room temperature with increasing vinyl acetate contents of to 50%. At a vinyl acetate content around 55 to 60% the last traces of crystallinity tend to disappear, and the polymers tend to become fully amorphous. Such polymers are no thermoplastic resins anymore but rather amorphous elastomeric polymers. The glass transition temperature (Tg) of the amorphous polymers increases with increasing amounts of incorporated vinyl acetate monomer units. At a content of vinyl acetate units of 90% wt the Tg is around room temperature and at a vinyl acetate content of 100% (corresponding to a polyvinyl acetate homopolymer), the Tg is between 30° C. and 40° C., typically. Preferably, the polymers are amorphous. Preferably they have a glass transition temperature of less than 29° C. The Tg can be measured via DSC by using the second temperature sweep (20 K/min) to identify the glass transition. The Tg is then the midpoint of the Tg slope. All DSC measurements can be done according to ASTM E 1356-03 or DIN 11357-2.

The vinyl-derived polymers according to the present disclosure may have at least one of the following properties: (i) a weight averaged molecular weight (Mw) of 100.000 to 160.000 g/mol, a number average molecular weight (Mn) of from. 50.000 to 80.000 g/mol or (iii) a ratio of Mw/Mn of 1.8 to 3.5. In a preferred embodiment according to the present disclosure, the polymer has all of properties (i) to (iii). The molecular weight can be determined by gel permeation chromatography (GPC) in THF at room temperature using and RI detector. The elution time gives the molecular weight base on a calibration with polystyrene samples of known molecular weight. All measurements can be done according to DIN 55672-1:2007-08.

The vinyl-derived polymers according to the present disclosure may further comprise units derived from one or more comonomers other than ethylene and vinyl acetate. In one embodiment of the present disclosure the vinyl-derived polymer comprises from 0 to 20% by weight, based on the weight of the polymer which is 100%, of units derived from one or more co-polymerizable monomer. Suitable co-polymerizable monomers include, for example, acrylic acids, methacrylic acids, glycidyl methacrylates and combinations thereof.

Useful vinyl-derived polymers according to the present disclosure include polymers comprising units derived from ethylene and vinyl acetate that have a melt-flow index (MFI) at 196° C. and a load of 2.16 kg of 10 to 250 g/10 min, preferably from 10 to 100 g/10 min, or from 30 to 100 g/10 min. Although amorphous and elastomeric ethylene-vinylacetate copolymers with such MFI values are too flowable for determining the Mooney viscosity, which is usually used to characterize elastomeric polymers.

In one embodiment of the present disclosure the vinyl-derived polymer has at least 8% by weight of units derived from ethylene and from 62% and up to 92% by weight of units derived from vinyl acetate and has a melt-flow index (MFI) at 196° C. and a load of 2.16 kg of 10 to less than 15 g/10 min

In one embodiment of the present disclosure there are provided vinyl-derived polymers comprising at least 8% by weight of units derived from ethylene and from 70% to 85% by weight of units derived from vinyl acetate that have a melt-flow index (MFI) at 196° C. and a load of 2.16 kg of 10 to 250 g/10 min, or from 10 to 100 g/10 min. Preferably, such polymers have a content of units derived from vinyl acetate of greater than 70% and up to 85% by weight.

In another embodiment of the present disclosure the vinyl-derived polymer has at least 8% by weight of units derived from ethylene and from 70% and up to 85% by weight of units derived from vinyl acetate and has a melt-flow index (MFI) at 196° C. and a load of 2.16 kg of 10 to 70 g/10 min, from 10 to less than 15 g/10 min or from 15 to 70 g/10 min. Preferably, such polymers have a content of units derived from vinyl acetate of greater than 70% and up to 85% by weight.

Preferably, the vinyl-derived polymers according to the present disclosure are soft materials. Preferably, the vinyl-derived polymers have a shore A hardness of less than 60, less than 50 or even less than 40 when subjected to a curing test. For the curing test a test composition is prepared as follows:

100 phr vinyl-derived polymers are mixed with 1 phr stearic acid and 1.8 phr bisperoxide (40% peroxide). The total weight of the test composition is 102.8 phr. The test composition is cured and determined for its Shore A hardness. Shore A hardness can be determined according to ASTMD2240 or DIN ISO 7629-1, preferably ASTMD2240.

Preferably the vinyl-derived polymers according to the present disclosure have a density between 1.00 and 1.20 g/cm³.

Suitable ethylene vinyl acetate copolymers are commercially available under a variety of trade designations including, e.g., the LEVAMELT series of trade designations from ARLANXEO including LEVAMELT 686. Vinyl-derived polymers with a vinyl acetate content of greater than 68% wt. can be obtained as described in the experimental section, for example by a radical solution polymerization, preferably with a nitrile group containing radical initiator. Preferably, the polymerization is carried out at elevated and constant pressure and at a temperature above room temperature, preferably at increasing temperature intervals, for example around 50 to 70° C.

It has been found that the vinyl-derived polymers according to the present disclosure improve the properties of polyurethane-comprising compositions, including curable and cured adhesives and films. The improved properties include an increased open time. Vinyl-derived polymers with a vinyl acetate content of at least 70% by weight, preferably greater than 70% by weight and an MFI (196° C., 2.16 kg) of at least 10 g/10 min improve the initial green strength of such compositions. Polyurethane-comprising composition comprising one or more vinyl-derived according to the present disclosure with a vinyl acetate content of at least 70% by weight, preferably greater than 70%, and an MFI (196° C.; 2.16 kg) of at least 10 g/10 min have a greater transparency than comparative compositions with vinyl-derived copolymers of similar MFI (196° C.; 2.16 kg) but lower vinyl acetate content.

Since both, ethylene and vinyl acetate, can be obtained from renewable or sustainable resources, 100% biobased or 100% sustainable vinyl-derived polymers can be produced. If used in polyurethane-comprising compositions, the renewable content of such compositions can be increased and thus their CO₂-footprint can be reduced. The vinyl derived polymers according to the present disclosure may have a bio-based carbon content of at least 5%, 10%, 20%, 30%, 40%, 50%, 60%, 70%, 80% or even greater than 90% as determined according to ASTM D6866-18, method B.

The vinyl derived polymers typically can be used in amounts of from about 5% to about 30% by weight to 100% by weight of prepolymer, preferably between 10% and 25% by weight, more preferably between 10 and 20% by weight.

### Further Additives

The adhesive compositions may contain one or more additives as known for use in PUR hot melt adhesives.

Typical examples include tackifying agents, catalysts and thermoplastic or elastomeric polymers. Thermoplastic and elastomeric polymers as described in United States patent application No. US 2021/0062055A1, incorporated herein by reference, can be used.

### Tackifiers

Tackifying agents preferably have a ring and ball softening point of greater than 100° C., greater than 110° C., greater than 120° C., greater than 135° C., or even greater than 145° C. Useful tackifying agents have a volatile organic content (voc) of greater than 500 ppm, greater than 1000 ppm, no greater than 1500 parts per million (ppm), no greater than 1000 ppm, no greater than 750 ppm, no greater than 600 ppm, no greater than 500 ppm, no greater than 400 ppm, or even no greater than 300 ppm (as reported by the manufacturer). The tackifying agent can be a mixture of at least two tackifying agents in which one tackifying agent has a greater voc than another including, e.g., one tackifying agent has a voc greater than 500 ppm and one tackifying agent has a voc content less than 500 ppm. Useful tackifying agents may be derived from an aromatic moiety and ethylene and include, e.g., aromatic resins, aromatic-aliphatic resins (e.g., aromatic-aliphatic petroleum hydrocarbon resins), and combinations thereof. Suitable aromatic tackifying agents include tackifying agents derived from, e.g., styrene, alpha-methyl styrene, vinyl toluene, methoxy styrene, tertiary butyl styrene, chlorostyrene, indene, methylindene, coumorone-indene, and combinations thereof, optionally copolymerized with at least one ethylenically unsaturated monomer (e.g., 1,3-butadiene, cis-1,3-pentadiene, trans-1,3-pentadiene, 2-methyl-1,3-butadiene, 2-methyl-2-butene, cyclopentadiene, dicyclopentadiene, and combinations thereof).

Useful aromatic-aliphatic petroleum hydrocarbon resins include, e.g., C9-based resins, dicyclopentadiene-based resins, C5/C9 copolymer-based resins, and combinations thereof.

The hot melt adhesive composition may include no or at least 5% by weight, from 10% by weight to no greater than 60% by weight, at least 10% by weight, from 15% by weight to 55% by weight, from 15% by weight to 50% by weight, from 5% by weight to 35% by weight, or even from 20% by weight to 45% by weight of one or more tackifying agent.

### Catalysts

The moisture curable hot melt adhesive composition may optionally include a catalyst to increase the cure reaction rate. Useful catalysts include catalyst include ether and morpholine functional groups, examples of which include di(2,6-dimethyl morpholinoethyl) ether and 4,4′-(oxydi-2,1-ethanediyl)bis-morpholine (DMDEE). Suitable commercially available catalysts include, e.g., JEFFCAT DMDEE 4,4′-(oxydi-2,1-ethanediyl)bis-morpholine. Other suitable catalysts include, e.g., metallic carboxylates and dibutyl tin dilaurate. Useful metallic carboxylates include, e.g., cobalt carboxylates, manganese carboxylates, and mixtures thereof. When a catalyst is present, the adhesive composition may include from about 0.01% by weight to about 0.5% by weight catalyst based on the weight of the adhesive composition.

In some embodiments, the moisture-curing catalyst is present during the formation of the polyurethane prepolymer and becomes incorporated into the backbone of the polyurethane prepolymer.

### Auxiliaries

The hot melt adhesive composition optionally includes a variety of additional components as known in the art including, e.g., antioxidants, stabilizers, additional polymers (e.g., styrene block copolymers, vinyl alcohol copolymers, and combinations thereof), adhesion promoters, ultraviolet light stabilizers, adhesion promoters (i.e., silane-based adhesion promoters), rheology modifiers, corrosion inhibitors, colorants (e.g., pigments (e.g., carbon black (e.g., PTMEG dispersed carbon black)) and dyes), fillers, flame retardants, nucleating agents, and combinations thereof.

Useful antioxidants include, e.g., pentaerythritol tetrakis [3, (3,5-di-tert-butyl-4-hydroxyphenyl) propionate], 2,2′-methylene bis(4-methyl-6-tert-butylphenol), phosphites including, e.g., tris-(p-nonylphenyl)-phosphite (TNPP) and bis(2,4-di-tert-butylphenyl) 4,4′-diphenylene-diphosphonite, di-stearyl-3,3′-thiodipropionate (DSTDP), and combinations thereof. When present, the adhesive composition preferably includes from about 0.1% by weight to about 2% by weight antioxidant. Useful optional fillers include, e.g., fumed silica, wollastonite, and combinations thereof.

### Preparation

The moisture curable adhesive composition according to the present disclosure can be formed by suitable methods as known in the art. Preferably, the isocyanate and the viny-derived polymer are combined with the one or more polyol wherein the one or more polyol is in a liquid state. However, the vinyl-derived polymer may also be added after the prepolymer has been formed, i.e. is can be added to the prepolymer, preferably when the prepolymer is in molten form. An advantage of the vinyl-derived polymers according to the present disclosure is that they can be added to the polyol or the prepolymer at comparative low temperatures, for example at temperatures not exceeding 140° C., for example between 100° C. and 140° C., where they dissolve easily in the polyol or the prepolymer. Preferably, the vinyl-derived polymers are added to one or more polyol at a temperature between 100° C. and 140° C., before the isocyanate is added. The temperature may be removed before the isocyanate is added, depending on the reactivity of the isocyanate. Other additives, if present, can be added simultaneously or sequentially as known in the art. The resulting adhesive composition is transferred into a moisture-free container for storage.

### Use

The moisture curable adhesive composition according to the present disclosure is useful in a variety of applications including, e.g., permanently bonding two substrates together and preventing the movement of a first substrate relative to a second substrate. The moisture curable adhesive composition can be formulated to be suitable for use in bonding substrates having a variety of properties including, e.g., polar substrates, nonpolar substrates, rigid substrates (i.e., the substrate cannot be bent by an individual using two hands or will break if an attempt is made to bend the substrate with two hands), flexible substrates (e.g., flexible substrates (i.e., the substrate can be bent using no greater than the force of two hands), porous substrates, conductive substrates, insulating substrates, transparent substrates, and combinations thereof, and substrates in a variety of forms including, e.g., sheets (e.g., metal sheet, polymer sheet, glass sheet, continuous sheets, discontinuous sheets, and combinations thereof), films (e.g., polymer film, metallized polymer film, continuous films, discontinuous films, and combinations thereof), foils (e.g., metal foil), fibers, threads, yarns, wovens, nonwovens, and combinations thereof.

The moisture curable adhesive composition can be formulated to be suitable for use in bonding a variety of substrates together including substrates that include, e.g., polymer (e.g., polycarbonate, polyolefin (e.g., polypropylene, polyethylene, low density polyethylene, linear low density polyethylene, high density polyethylene, polypropylene, and oriented polypropylene, copolymers of polyolefins and other comonomers), polyether terephthalate, ethylene-vinyl acetate, ethylene-methacrylic acid ionomers, ethylene-vinyl-alcohols, polyesters, e.g. polyethylene terephthalate, polycarbonates, polyamides (e.g. nylon-6 and nylon-6,6), polyvinyl chloride, polyvinylidene chloride, cellulosic materials, polystyrene, and epoxy), polymer composites (e.g., composites of a polymer and metal, cellulose, glass, polymer, and combinations thereof), metal (aluminum, copper, zinc, lead, gold, silver, platinum, and magnesium, and metal alloys such as steel, tin, brass, and magnesium and aluminum alloys), carbon-fiber composite, other fiber-based composite, graphene, glass (e.g., alkali-aluminosilicate toughened glass and borosilicate glass), quartz, boron nitride, gallium nitride, sapphire, silicon, carbide, ceramic and combinations thereof. Particularly useful applications include bonding a polycarbonate substrate to a polypropylene substrate through the cured adhesive composition.

The moisture curable adhesive composition is suitable for use in a variety of industrial applications including, e.g., adhering components of automobiles, sealing components of automobiles, applications in the automotive industry (e.g., vehicle construction (e.g., headlamp construction)), recreational vehicles, window construction, appliances, filters, electronic assemblies, wood materials, plastic materials, laminated panels, edge-banding, profile wrapping, packaging, and textiles.

The adhesive composition can be applied using any suitable application method including, e.g., manual or automatic fine line dispensing, slot die coating, roll coating, gravure coating, transfer coating, pattern coating, screen printing, spray coating, filament coating, by extrusion, air knife, trailing blade, brushing, dipping, doctor blade, offset gravure coating, rotogravure coating, and combinations thereof. The moisture curable adhesive composition can be in a continuous or discontinuous (e.g., pattern) form and can be applied as a bead, coating, layer (e.g., a single layer and multiple layers), and combinations thereof.

Preferably, the moisture-curable adhesive according to the present disclosure is a hot melt adhesive and is applied to the substrate for bonding after it has been heated into a liquid form. Preferably, the adhesive composition may be applied at any suitable temperature including, e.g., temperatures from 120° C. to 190° C., or from 140° C. to 180° C.

Preferably, the adhesive composition is solvent-free.

Another advantage of the moisture-curable adhesive compositions according to the present disclosure with the vinyl-derived resin is their improved transparency and glue lines made with the adhesive composition may be less visible. Improved transparency is also a particular advantage for making coatings, for example thin or thick films. Therefore, there is also provided a coating made by applying a composition according to the present disclosure onto a substrate and subjecting the composition to curing. There is also provided a process comprising applying a composition according to the present disclosure onto a substrate and subjecting the composition to curing. The surface of the substrate on which the moisture curable adhesive composition is applied optionally may be treated to enhance adhesion using any suitable method for enhancing adhesion to the substrate surface including, e.g., corona treatments, chemical treatments, flame treatments, and combinations thereof.

It is to be understood that the ethylene-vinyl acetate copolymers according to the present disclosure may also be used in applications other than adhesive applications or in applications not requiring the presence of any polyurethanes. Typical application may include, but are not limited to, the use as:
(i) tie layer or a component of a tie layer in multi-layer articles including multi-layer-films,
(ii) a binder or component of a binder, including binder for master-batching of reactive chemicals or binder in battery applications, for example as binder of an anode or a cathode material,
(iii) a polymeric plasticizer or component thereof, including plasticizer for thermoplastic resins including, for example, polyvinyl chlorides,
(iv) as impact modifier preferably of thermoplastic resins or
(v) as ingredient of foams.

They may be used as additives for rubber compositions are thermoplastic materials as described, for example, in GB1389342 and EP4071213A1.

If used in layered articles, the ethylene-vinylacetate copolymers according to the present disclosure may be present in an interior, an exterior or an intermediate layer.

The ethylene-vinylacetate copolymers according to the present disclosure may also be used as cable sheaths or tubing or as a component thereof. Cables include but are not limited to coaxial cables, twisted pair cables, power cables including high voltage and low voltage cables, optical fiber cables, data cables, continuous-flex cables.

The ethylene-vinylacetate copolymers according to the present disclosure may also be used as component for making blends with other rubbers or with one or more thermoplastic polymers, including, for example, blends with polyamides, for example to produce thermoplastic vulcanizate (TPV's) EP2098566B1 or thermosets as disclosed for example in EP2895552B1.

The ethylene-vinylacetate copolymers according to the present disclosure may be used as a component of adhesive compositions other than polyurethane adhesives. Such adhesives include, for example, pressure-sensitive adhesives (PSA's), solvent-based adhesives, moisture-curing adhesives, hot-melt adhesives. The ethylene-vinylacetate copolymers according to the present disclosure EVA-copolymers may also be used as components of adhesives tapes, including double-sided tapes and masking tapes. The ethylene-vinyl acetate copolymers according to the present disclosure may also be used to impart flame retardancy or improve damping behavior.

The following examples are provided to further illustrate the present disclosure without, however, intending to limit the disclosure to the embodiments set forth in these examples.

### EXAMPLES

### Preparation of Amorphous EVA:

923 g t-butanol, 2035 g vinylacetate and 250.3 g of activator solution were added subsequently into a 5 L vessel at room temperature. The activator solution contained 0.38 g AIBN and 250 g of a solution of vinalyacetate in butanol (20% vinyl aceate). The reactor was charged with nitrogen and subsequently with 566 g ethene and the reactor reached a pressure of 130 bar. The reactor was heated to 60° C. and the pressure in the reactor was kept constant at about 380 bar by feeding ethene. The reaction was carried out for 4 to 7 h and the temperature was increased in interval up to 75° C. In some procedures AIBN (azobisisobutylnitrile) was replaced with ADVN (2,2′-azobis-2,4dimethylvaleronitrile).

Several amorphous ethylene vinylacetate copolymers with a vinyl acetate content between 75 and 85% wt and MFI's ranging from about 15 to 70 g/10 min. a molecular weight (Mw) were prepared this way. The polymers had a molecular weight (Mw) of 100.000 to 160.000 g/mol, a number averaged molecular weight (Mn) of from. 50.000 to 80.000 g/mol, an Mz of from about 50.000 to about 60.000 to 300.000 g/mol and a PDI (Mw/Mn) of 1.8 to 3.5

### PUR Adhesive Compositions:

### Materials:

Dynacoll® 7361: a solid, partially crystalline, saturated polyester polyol (Tm 57° C.) from Evonik Industries AG.
Dynacoll® 7130: a solid, amorphous, saturated polyesterpolyol (Tg 30° C.) from Evonik Industries AG.
PPG N-210: a polyether polyol (Mn 1000 g/mol) from Nanjing Zhongshan.
Desmodur® 44C: polyisocyanate crosslinker (MDI-type) from Covestro.
DMDEE: 2,2′-dimorpholinodiethyl ether catalyst.
Levamelt® 456: ethylene-vinylacetate copolymer (VA content 45%, MFI 25 g/10 min) from ARLANXEO Deutschland GmbH
Levamelt® 686: ethylene-vinylacetate copolymer (VA content 68%, MFI 25 g/10 min) from ARLANXEO Deutschland GmbH.
Vinnapas® B60: polyvinyl acetate homopolymer from Wacker (solution viscosity 3.5-6.0 mPa s, 10% in ethyl-acetate).

### PUR Adhesive Preparation

The ethylene-vinyl acetate copolymer was dissolved into the polyether polyol PPG N210 at 120° C. (unless stated differently in the tables) and then the other polyols were added to the mixture. The resulting mixture was dehydrating in a vacuum for about 2.5 h at 150° C. to remove moisture. The temperature of the mixture was then reduced to 80° C. and methylene diphenyl diisocyanate was added under nitrogen atmosphere and reacted for 1.5 hours to create the prepolymer. DMDEE was added under nitrogen atmosphere and the mixture was stirred for 0.5 hours. The resulting adhesive composition was stored in a moisture-free container.

### Example 1 and Comparative Examples C1-C9

Various PUR adhesive compositions were prepared, and their open times were determined. For this measurement the adhesive was coated along the long side of a sheet of kraft paper with a thickness of 200 micron. The non-coated side of the kraft paper sheet was cut into vertical strips, 2 cm broad, with a fold parallel to the adhesive line. Starting from one side of the adhesive the paper strips were periodically in time applied on the adhesive by gently pressing, each time a new strip. Once a strip would not stick to the adhesive anymore the open time was considered as passed. The time starts when the coating is just completed.

TABLE 1
amounts of ingredients and the open time of the adhesives.

| | DYNACOLL | DYNACOLL | PPG2000 | MDI | DMDEE | LEVAMELT | Open |
|---|---|---|---|---|---|---|---|
| | 7361 [wt. %] | 7130 [wt. %] | [wt. %] | [wt. %] | [wt. %] | 686 [wt. %] | time [s] |
| C1 | 66 | 4 | 18 | 11.97 | 0.03 | | 75 |
| C6 | 66 | 18 | 4 | 11.97 | 0.03 | | 75 |
| C7 | 53.83 | 26.91 | 7.22 | 12.01 | 0.03 | | 185 |
| C2 | 51 | 6 | 28 | 14.97 | 0.03 | | 120 |
| C8 | 51 | 28 | 6 | 14.97 | 0.03 | | 120 |
| C3 | 44 | 10 | 34 | 11.97 | 0.03 | | 370 |
| C4 | 37 | 12 | 33 | 17.97 | 0.03 | | 540 |
| C5 | 38 | 34 | 13 | 14.97 | 0.03 | | 375 |
| Ex 1 | 38 | 34 | 13 | 14.97 | 0.03 | 10 | 795 |
| C9 | 37 | 33 | 12 | 17.97 | 0.03 | | 420 |

As can be seen in table 1 the addition of an amorphous EVA resin (example 1, Ex1) considerably raised the open time.

### Examples 2-4 and Comparative Examples C9-C15

PUR adhesives with different EVA resins in different amounts and a polyvinyl acetate were prepared. The prepolymer component of the adhesive compositions was kept the same throughout all experiments (prepared by reacting 53.88 wt % DYNACOLL 7361, 26.91 wt. % DYNACOLL 7130, 7.22 wt. % PPG2000, 12.01 wt. % MDI, 0.03 wt. % DMDEE, total 100% wt). A vinyl acetate homopolymer (not according to the invention) and two EVA polymers with different vinyl acetate content (45%; crystalline; not according to the invention and 68%; amorphous, according to the invention) were added in various amounts to 100% wt of prepolymer composition. As can be seen in table 2 both amorphous and crystalline EVA polymers increased the open time compared to the polyvinyl acetate additive, but the amorphous EVA could be added much easier than the crystalline EVA. The amorphous EVA polymer dissolved completely within 45 min at a temperature of 120° C. while the crystalline EVA had not dissolved completely after a period of more than 60 minutes under the same conditions.

TABLE 2
amounts of ingredients and the open time of the adhesives

| | LEVAMELT | VINNAPAS | LEVAMELT | Dissolution | Coating | Coating | Open |
|---|---|---|---|---|---|---|---|
| | 686 [wt %]* | B60 [wt %]* | 456 [wt %]* | at 120° C. | at 120° | at 150° C. | time [s] |
| C10 | | | | | smooth | smooth | 180 |
| 2 | 10 | | | very good | smooth | smooth | 277 |
| 3 | 20 | | | very good | coarse | smooth | 262 |
| 4 | 30 | | | very good | coarse | slightly | 285 |
| | | | | | | coarse | |
| C9 | | 10 | | very poor | few | | 88 |
| | | | | | particles | | |
| C11 | | 20 | | very poor | many | | 66 |
| | | | | | particles | | |
| C12 | | 30 | | very poor | n.d. | | n.d. |
| C13 | | | 10 | good | few | | 345 |
| | | | | | particles | | |
| C14 | | | 20 | poor | many | | 292 |
| | | | | | particles | | |
| C15 | | | 30 | very poor | many | | 307 |
| | | | | | particles | | |

*the resin additives were added to 100 wt % of prepolymer;
Very good = dissolved within 45 min; good = some particles remained after 60 min; poor = many particles after 60 min; very poor = almost insoluble;
n.d. = not determined because measurement was not possible.

### Example 5: Trials with Amorphous EVA of Different MFI's

In this series of trials the same PUR prepolymer composition as above was used. Amorphous EVA resins (LEVAMELT 800) with a vinyl acetate content of 80% but different melt flow indices between 18 and 67 were added to 100 wt % of the prepolymer at a level of 15%. The dissolution speed for examples 5 to 15 was very fast and did not exceed 30 minutes (compared to 45 min of LEVAMELT 686 in table 2). The viscosity of the composition at 120° C. and shear rate of 300 s⁻¹ were similar for all MFI ranges and were similar to that of L686 with values about 30 mPas. The open time for MFI values of 18 to 67 remained between 5 and 8 minutes and which are desirable open times. An adhesive composition prepared with the same EVA resin at MFI of 5 was too viscous at the temperatures applied to determine open times and therefore, the open time could not be determined.

The adhesive compositions prepared with the amorphous EVA having 80% vinyl acetate content were very clear and reached a peel strength between 15 and 35 N/25 mm after 6 minutes. Adhesive compounds prepared with an amorphous EVA having 68% vinyl acetate content were somewhat opaque. Both amorphous EVAs gave transparent films indicating clear and transparent bond lines at least when applied as thin films.

### Example 6: Increased Green Strength

Polyurethane hot melt adhesive compositions comprising various ethylene-vinylacetate copolymers were applied to various substrates for measuring the shear tack/force after 1.5 minutes. The test specimens were 50 mm×25 mm×2 mm. Haul-off speed was 300 mm/min.

The test substrates were polyamide-6 (PA6) and polymethyl methacrylate (PMMA).

Ex 6A was a reference polyurethane adhesive composition comprising no ethylene-vinylacetate copolymer.

Ex 6B was an adhesive composition with the same adhesive as in example 6A but comprising a comparative ethylene-vinylacetate copolymer with a VA content of 45% and an MFI of 25 g/10 min.

Ex 6C was an adhesive composition with the same adhesive as in example 6A but comprising an ethylene-vinylacetate copolymer with a VA content of 68% by weight and an MFI of 25 g/10 min

Ex 6D was an adhesive composition with the same adhesive as in example 6A but comprising an ethylene-vinylacetate copolymer with a VA content of 80% by weight and an MFI of 18 g/10 min.

TABLE 3

| | PA6/ | PA6/ | PA6/ | PA6/ | PMMA/ | PMMA/ | PMMA/ | PMMA/ |
|---|---|---|---|---|---|---|---|---|
| Substrate | PA6 | PA6 | PA6 | PA6 | PMMA | PMMA | PMMA | PMMA |
| Adhesive | 6A | 6B | 6C | 6D | 6A | 6B | 6C | 6D |
| composition | | | | | | | | |
| Shear force | 101 | 107 | 112 | 135 | 91 | 107 | 114 | 193 |
| [N] | | | | | | | | |

### Example 7: Increased Transparency

The transparency of a polyurethane hot melt adhesive compositions comprising no ethylene-vinylacetate (reference composition, Example 7A) was compared with the same hot melt composition comprising 15 phr of an ethylene-vinylacetate copolymer with a VA content of 68% by weight and an MFI of 25 g/10 min (in Example 7B) and with the same hot melt composition with an ethylene-vinylacetate copolymer with a VA content of 80% by weight and an MFI of 18 g/10 min (Example 7C). The comparison included also the comparison of cured films made from these compositions. The curable compositions and the cured films obtained from compositions 7A and 7C were the same as determined by visual inspection. The curable composition 7B was opaque but the cured film was transparent although less transparent than the films made from 7A and 7C.

1. An adhesive composition comprising a moisture-curable polyurethane-based adhesive and a polymer comprising units derived from ethylene and vinyl acetate and having a melt-flow index at 196° C. and a load of 2.16 kg of 10 to 250 g/10 min, wherein the polymer comprises at least 8% by weight of units derived from ethylene and from 62 to 92% by weight of units derived from vinyl acetate, wherein the % by weight is based a the total weight of the polymer which is 100%.

2. The adhesive composition of claim 1, wherein the polymer comprises from 69 to 85% by weight of units derived from vinyl acetate.

3. The adhesive composition of claim 1, wherein the polymer has at least one of the following properties: (i) a weight averaged molecular weight (Mw) of 100,000 to 160,000 g/mol, a number average molecular weight (Mn) of 50,000 to 80,000 g/mol or (iii) a ratio of Mw/Mn of 1.8 to 3.5, or (iv) a shore A of less than 40.

4. The adhesive composition according to claim 1, wherein the polymer comprises from 0 to 20% by weight of units derived from one or more co-polymerizable monomers selected from acrylic acids, methacrylic acids, glycidyl-methacrylates, and combinations thereof.

5. The adhesive composition according to claim 1, wherein the adhesive composition is a hot melt adhesive.

6. The adhesive composition according to claim 1, wherein the polyurethane-base adhesive comprises a prepolymer that includes the reaction product of an excess of at least one polyisocyanate with at least one polyol.

7. The adhesive composition according to claim 1, wherein the polyurethane-based adhesive comprises a prepolymer that includes the reaction product of an excess of at least one polyisocyanate with at least two polyols, wherein a first polyol of said at least two polyols is selected from a hydroxy-functionalized polyester or a hydroxy-functionalized polyester ether or a combination thereof, and a second of said at least two polyols is a hydroxy-functionalized polyol is selected from a polyether polyol or a combination of polyether polyols.

8. The adhesive composition according to claim 1, wherein the polyurethane-based adhesive comprises a prepolymer that includes the reaction product of an excess of at least one polyisocyanate with at least two polyols, wherein a first polyol of said at least two polyols is selected from a combination of a crystalline hydroxy-functionalized polyester and a non-crystalline hydroxy-functionalized polyester and wherein a second polyol of said at least two polyols is a polyether polyol.

9. The adhesive composition according to claim 6, comprising from 5 to 30% by weight of the polymer, based on the total weight of the prepolymer which is 100% by weight.

10. The adhesive composition according to claim 1, wherein either the ethylene or the vinyl acetate or both are obtained from a sustainable resource selected from a renewable resource or from a recycled resource.

11. A vinyl-derived polymer comprising units derived from ethylene and vinylacetate and having a melt-flow index at 196° C. and a load of 2.16 kg of 10 g to 250 g/10 min, wherein the polymer comprises at least 8% by weight of units derived from ethylene and from greater than 70 and up to 92% by weight of units derived from vinyl acetate, wherein the % by weight is based on a total weight of the polymer which is 100%.

12. The polymer according to claim 11, comprising from 0 to 20% by weight based on the total weight of the polymer which is 100% of units derived from one or more co-polymerizable monomers selected from acrylic acids, methacrylic acids, glycidyl-methacrylates, and combinations thereof.

13. The polymer according to claim 11, wherein the polymer has at least one of the following properties: (i) a weight averaged molecular weight (Mw) of 100,000 to 160,000 g/mol, a number average molecular weight (Mn) of 50,000 to 80,000 g/mol or (iii) a ratio of Mw/Mn of 1.8 to 3.5.

14. A process of making an adhesive composition according to claim 1 comprising:
a) dissolving the polymer into at least one polyol to obtain a mixture,
b) reacting the mixture obtained in a) with at least one polyisocyanate, and, optionally,
c) adding at least one additive.

15. A bonded substrate comprising a bond obtained with the adhesive composition according to claim 1.

16. A method of bonding a substrate comprising applying an adhesive composition according to claim 1 between a first substrate and a second substrate such that the first and second substrate are at least partially connected to each other by the adhesive composition and subjecting the adhesive composition to curing to bond the first substrate to the second substrate.

17. A method of preparing a coating comprising applying an adhesive composition according to claim 1 onto a substrate and subjecting the adhesive composition to curing.

18. A coated substrate obtainable by the method of claim 17.
